(19) United States
(12) Patent Application Publication
(10) Pub. No.: US 2003/0110287 A1
(43) Pub. Date: Jun. 12, 2003

(54) Fast recovery method in label switching networks, and network arrangement to carry out the method

(76) Inventor: Geoffrey Mattson, Nashua, NH (US)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/054,186

(22) Filed: Jan. 22, 2002

(30) Foreign Application Priority Data
Dec. 7, 2001 (EP) 01 403176.9

(51) Int. Cl. G06F 15/173

(52) U.S. Cl. 709/238

(57) ABSTRACT

A primary label switched path (LSP) defined in a label switching network has a protected portion for transmitting data packets containing a label stack from a first label switching node to a second label switching node, the protected portion including at least one intermediate label switching node between the first and second nodes. To provide path recovery resources in case of link or node failure, it is proposed a method in which a backup LSP is defined from the first node to the second node. A transformation of the label stack of a packet transmitted along the protected portion of the primary LSP from an output of the first node to an input of the second node is determined. The first node is configured to switch a packet to the backup LSP upon detection of a failure in the protected portion of the primary LSP. In addition, a node of the backup LSP is configured to process the label stack of any packet transmitted along the backup LSP so as to apply the determined transformation.

### BACKGROUND OF THE INVENTION

The present invention relates to the recovery from failure in a telecommunication network.

In a telecommunication network, where voice and data—sometimes for real time applications—can be transmitted, it is necessary to have a recovery method in case of failure.

Many networks propose recovery solutions. For instance, in an IP (Internet Protocol) network, each router has a table which reveals the next hop it must perform according to the IP address of the destination included in every incoming packet. If a failure occurs on a link between two routers, several routers of the network will modify their routing table, to be able to overcome the failure by modifying the next hop to be done, which will allow the packets they deliver to be routed to their destination in spite of the link failure.

Some protocols define the way of building such routing tables. For example, OSPF (Open Shortest Path First) is a route-link protocol, based on conditions of the links. It is detailed in the Request for Comments (RFC) 1245, published by the Internet Engineering Task Force (IETF) in July 1991.

However, the recalculation of the routing tables is not instantaneous, and sometimes it can lead to different conclusions depending on the routers. So, a convergence time is necessary to get to a complete recovery. Typically, the duration may be of the order of 20 seconds, which is too long, particularly for time-sensitive applications like voice calls or other real-time transmissions.

Another solution is based on the Multi-Protocol Label Switching (MPLS) technology which can be used in an infrastructure supporting a connectionless network layer protocol such as IP. A recovery method based on MPLS circumvents the need to carry out immediately the above layer 3 processing.

MPLS is described in RFC 3031 published in January 2001 by the IETF. A MPLS packet is assigned to a FEC (Forwarding Equivalence Class) at the entrance into the MPLS network, in a node called LER (Label Edge Router). The FEC is identified with a label whose size is small and fixed. The label is added to the packet by the LER before the next hop. In the following nodes, called LSR (Label Switch Routers), the label is used as an index into a table which specifies the next hop. A path followed by the packets of a FEC is called a LSP (Label Switched Path). Each LSR along the LSP may also perform label manipulations of its own, by adding (pushing), suppressing (popping) or changing (swapping) labels in the MPLS header. There is no further analysis of the network layer header of the packets in the LSRs.

A signaling protocol, such as LDP (Label Distribution Protocol, see RFC 3036 published in January 2001 by the IETF) or RSVP (Resource reSerVation Protocol, see Internet Draft “draft-ietf-mpls-rsvp-lsp-tunnel-09.txt” published in August 2001 by the IETF) is used to distribute labels and establish point-to-point paths within the MPLS network.

MPLS-based recovery solutions are sometimes referred to as “local repair”. An example of such local repair mechanism is described in the Internet Draft “draft-pan-rsvp-fastreroute-00.txt” published by the IETF. Let us consider a protected LSP passing through four routers A, B, C and D. A backup LSP may be configured to handle failures of the link between B and C. Such backup LSP passes through at least one additional LSR, say E, and merges with the protected LSP downstream of this link, for example in router C. When B detects a failure of the link between B and C, it switches the incoming packets of the protected LSP to the backup LSP while pushing a label of this backup LSP. Router E, or more generally the penultimate router of the backup LSP, pops this label off the MPLS stack to deliver the packets to C. The local repair mechanism provides the path recovery function quickly. After a certain delay, the function is taken over by a conventional layer 3 mechanism of updating the routing tables.

The backup LSP may also span more than two successive links of the protected LSP. For example, in the previous case, the two LSPs may merge in router D. This may provide the path recovery function in cases where the failure detected by B occurs in router C. However, it is inoperative whenever the backup LSP bypasses a LSR which performs some action on the MPLS label stack (pushing, popping, swapping). In our example, if C changes the label stack, D will not get the packets with the correct labels along the backup LSP and therefore will not switch or process them as required.

An object of the present invention is to overcome the above limitation of known local repair methods.

### SUMMARY OF THE INVENTION

The invention proposes a method of providing backup resources for a primary LSP in a label switching network, the primary LSP having at least a portion for transmitting data packets containing a label stack from a first label switching node to a second label switching node, said portion including at least one intermediate label switching node between the first and second nodes. The method comprises the steps of:

defining at least one backup LSP starting from the first node and merged with the primary LSP at the second node;

determining a transformation of the label stack of a packet transmitted along said portion of the primary LSP from an output of the first node to an input of the second node;

configuring the first node to switch a packet to the backup LSP upon detection of a failure in said portion of the primary LSP; and

configuring at least one node of the backup LSP to process the label stack of any packet transmitted along the backup LSP so as to apply said transformation.

Accordingly, the nodes of the backup LSP can be configured to achieve the path recovery function even when the label stack is transformed along the protected path portion. In practice, such transformations are very frequent as soon as the backup LSP bypasses one or more nodes. The simplest transformation is a label swap, which may be a combination of several individual swap operations. It can also be more complex in cases of nested LSPs: there may be additional push and/or pop operations along the protected path portion depending on the positions of the first and second nodes relative to the nested tunnel ends.

There are different manners to automatically determine the relevant transformation of the label stack, for example by including in messages of a signaling protocol indications of individual label stack manipulations performed by the nodes of said portion of the primary LSP, or by transmitting sample packets from the first node to the second node along the primary LSP to detect the overall transformation.

The node of the backup LSP configured to apply the transformation is preferably the first node (the transformation being applied prior to pushing a label of the backup LSP) or the second node. This simplifies the operations to be performed by the nodes on the label stack.

In a particularly advantageous embodiment of the invention, the method further comprises the steps of defining at least one switchback LSP from an intermediate node of the primary LSP to the first node, and configuring said intermediate node to switch a packet to the switchback LSP upon detection of a failure in said portion of the primary LSP downstream of said intermediate node and up to the node situated next to said intermediate node. The first node can then be configured to switch to the backup LSP any packet received on the switchback LSP. The method may comprise the further steps of determining a second transformation of the label stack as the inverse of a transformation of the label stack of a packet transmitted along said portion of the primary LSP from the output of the first node to said intermediate node, and configuring at least one node of the switchback LSP to process the label stack of any packet transmitted from said intermediate node along the switchback LSP so as to apply said second transformation.

Such switchback LSP makes it possible to achieve path recovery when various links or nodes are likely to fail along the protected path portion, while consuming a relatively small amount of label resources.

Another aspect of the invention relates to a label switching network suitable for implementing the above-described method.

The preferred features of the above aspects which are indicated by the dependent claims may be combined as appropriate, and may be combined with any of the above aspects of the invention, as would be apparent to a person skilled in the art.

### BRIEF DESCRIPTION OF THE DRAWINGS

FIG. 1 is a schematic view of an embodiment of the invention in a very simple case.

FIG. 2 is a schematic view of an embodiment of the invention illustrating a switchback case.

### DESCRIPTION OF PREFERRED EMBODIMENTS

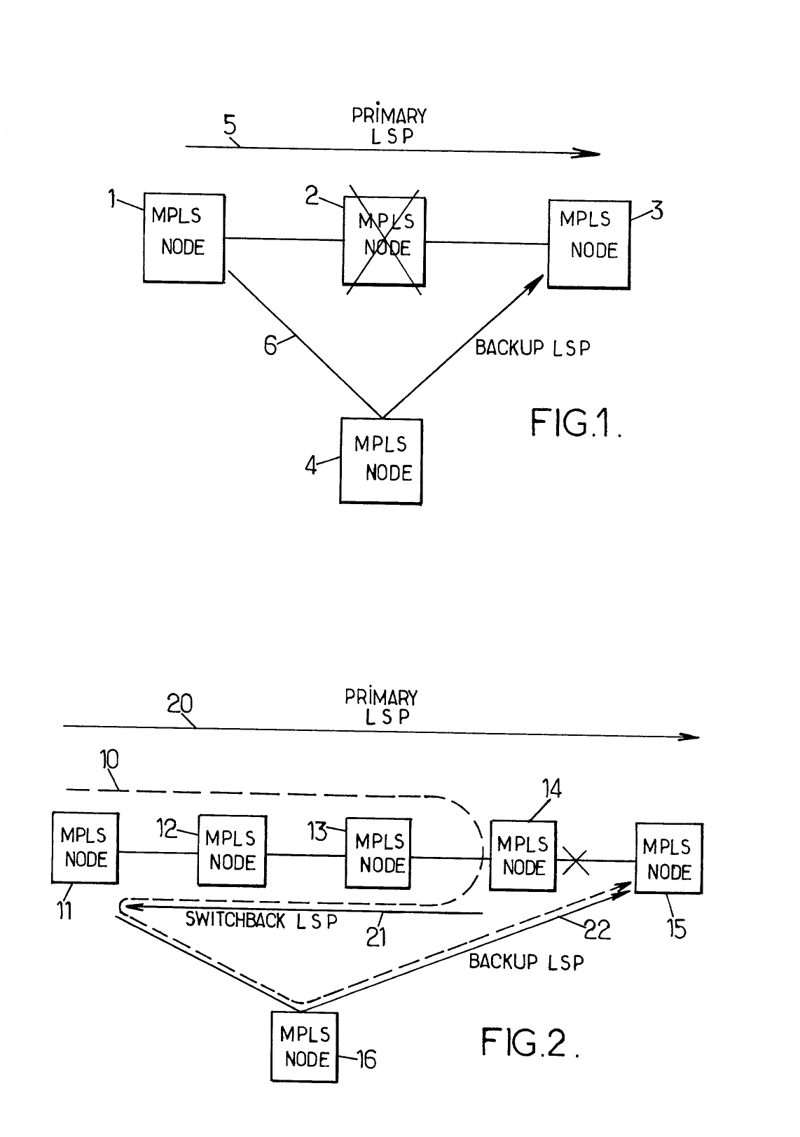

FIG. 1 illustrates diagrammatically a MLPS network in which a primary LSP 5 has been defined. The primary LSP 5 has a protected portion consisting of three successive MPLS nodes 1, 2, 3. Node 2 is a LSR in this example. Node 1 is a LER if the protected portion starts at the entrance of LSP 5, and a LSR if LSP 5 has one or more nodes upstream of its protected portion. Node 3 is a LER if the protected portion ends at the exit of LSP 5, and a LSR if LSP 5 has one or more nodes downstream of its protected portion.

As a backup resource, another LSP 6 has been defined in the MLPS network from node 1 to node 3 via an additional MPLS node (LSR) 4.

LSPs 5, 6 are established in a conventional manner by means of a signaling protocol such as LDP or RSVP.

Node 1 is configured to provide a local repair function when certain failures occur on the protected portion of the primary LSP 5.

Accordingly, when it detects such a failure, node 1 switches the traffic of the primary LSP to the backup LSP 6. To do so, it pushes a label allocated to the backup LSP on top of the label stack of each re-routed packet. This packet is tunneled into the backup LSP up to its egress node 3 where the backup LSP merges with the primary LSP 5. The penultimate node (4 in our example) of LSP 6 pops the label of the backup LSP off the label stack to deliver the packet to node 3 as it were when it entered the tunnel at node 1. The popping can also be performed at the input of the tunnel egress node 3.

However, the state of the label stack at the input of node 3 on the backup LSP 6 is not necessarily the same as it would have been had the packet been transmitted along the primary LSP 5. The reason is that label stack manipulations may occur in nodes of the protected portion of the primary LSP 5 (node 2 in the example of FIG. 1).

Such manipulations result from the establishment of the LSPs in the MLPS network, e.g. by means of LDP. For instance, the set of labels available on a given hop in view of the labels which have already been allocated to other LSPs on the same link may impose a label swap operation in an intermediate node of a LSP which is being established.

Other label stack manipulations may result from the MPLS architecture, particularly in the case of nested LSPs. For instance, assume that another nested LSP starts at node 2 toward node 3 along LSP 5: in such a case, node 2 pushes one or more LSP labels on top of the label stack of an incoming packet to be forwarded to node 3. Likewise, if a nested LSP ends at node 3 from nodes 1 and 2, node 2 may have to pop one or more LSP labels off the label stack of an incoming packet. More complex MPLS architectures can result in quite substantial transformations of the label stack along the protected portion of the primary LSP.

In order to cope with the inconsistencies of the label stacks when a packet of the primary LSP is received at node 3 from node 2 (protected portion of LSP 5) and from node 4 (backup LSP), a node of the backup LSP 6 is further configured to apply to the packet a label stack transformation determined to be the same as that resulting from the aggregated label operation performed along the protected portion of the primary LSP 5 from the output of node 1 to the input of node 3.

The node of the backup LSP 6 configured to apply this transformation is preferably at one end of the tunnel, i.e. the ingress node 1 or the egress node 3.

Two methods can be used for this node to determine the transformation to be applied. A first method uses an enhancement of the signaling protocol used to establish the LSPs, for example LDP. In this first method, when the labels are distributed along the path, each intermediate node inserts into the enhanced LDP message an indication depending of any label manipulation which it performs. It may be an indication of its individual label manipulation, or an indication of an accumulated transformation determined by combining the manipulation indicated in the message received from the upstream node with its individual label manipulation. This signaling message is initialized with an indication of no manipulation (identity transformation) at the entrance of the portion of the primary LSP which is to be protected. Therefore, the node 3 located at the exit of the portion to be protected receives a signaling message from which it readily determines the required transformation.

It is then quite simple to configure the egress node 3 of the backup LSP to apply the transformation to any packets tunneled therethrough. The egress node 3 may also signal back the transformation to the ingress node 1 if the latter is configured to apply the transformation to the tunneled packets.

In the second method, the protected portion of the primary LSP 5 is probed by transmitting a sample packet from the ingress node 1 to the egress node 3. The latter analyzes the sample packet as received along the primary LSP 5 to learn the relevant label stack transformation.

In the example shown in FIG. 1, the above-mentioned method provides quick path recovery if a failure occurs on the link between nodes 1 and 2 or in node 2. This is normally detected by the node located immediately upstream of the failure, i.e. node 1 which is at the entrance of the backup tunnel. If the local repair is to be provided for the link between nodes 2 and 3, it is possible to use an additional switchback path as described in more detail with reference to FIG. 2.

FIG. 2 shows a different LSP arrangement in the MPLS network, with a primary LSP 20 whose protected portion has an ingress node 11, an egress node 15 and three successive intermediate nodes 12, 13, 14. A backup LSP 22 is also defined from node 11 to node 15 via an intermediate LSR node 16. The backup LSP 22 is established as described previously, in particular in such a way that the label stack transformation applied along the protected portion of the primary LSP is also applied to packets tunneled through the backup LSP 22. Therefore, it provides local repair in case of failure of node 12 or of the link between nodes 11 and 12.

Furthermore, another backup LSP 21, called switchback LSP, is defined between nodes 14 and 11. In the advantageous configuration shown in FIG. 2, the switchback LSP 21 goes through the same nodes 13, 12 as the primary LSP 20, in the reverse direction, from node 14 to node 11.

The switchback LSP 21 can be used for local repair when a failure is detected on the protected portion of the primary LSP 20 downstream of the intermediate node 14 located at its entrance, and not farther than the node situated next to this intermediate node 14 along LSP 20 (that is when the failure occurs on the link between nodes 14 and 15 in the example shown).

As an additional configuration feature of the ingress node 11 of the backup LSP 22, the label switching table of this node 11 has an entry for switching any packet received from node 12 on the switchback LSP to the backup LSP 22 to be tunneled to node 15 as described previously.

At the entrance of the switchback LSP 21, node 14 is configured to switch any packet of the primary LSP 20 intended for the next node 15 back on the switchback LSP 21 if a failure is detected downstream. When doing so, node 14 pushes a label of the switchback LSP 21 on top of the label stack of the packet. This label is then popped at the penultimate or last node of the switchback LSP 21, i.e. at node 12 or 11.

To achieve the required label stack consistency when the packet finally arrives at node 15 (along path 10 depicted as a dashed line in FIG. 2), it is also necessary to apply to the label stack of this packet a transformation which is the inverse of the transformation undergone along the direct primary path 20 from the output of node 11 to the input of node 14. One of the nodes of the switchback LSP 21 is configured to apply this inverse transformation to the tunneled packets when a failure is detected downstream of node 14. Therefore, the overall transformation applied along the concatenation of LSP 21 and 22 corresponds to the transformation applied along the primary path 20 between the inputs of nodes 14 and 15. in other words, the concatenation of the LSP tunnels 21 and 22 acts as a backup LSP for protecting the portion of the primary LSP extending between nodes 14 and 15.

The node of the switchback LSP 21 which is configured to apply the inverse transformation is preferably the ingress node 14, the inverse transformation being applied prior to pushing the switchback LSP label. Node 14 learns the direct transformation between nodes 11 and 14 according to one of the methods described previously for the backup LSP, and inverts it to deduce the suitable inverse transformation.

Another remarkable feature of the switchback LSP 21 is that it can also be used by other intermediate nodes of the primary LSP 20 to increase the number of locally repairable failure scenarios. This advantage is achieved with only a moderate increase of the complexity of the label switching tables in the MPLS nodes.

For example, node 13 in FIG. 2 may be configured to directly insert packets into the switchback tunnel when it detects a failure downstream of the switchback LSP 21 and up to the next node 14. Of course, node 13 then has to determine the suitable inverse transformation that it should apply to such packets. This is done exactly in the same manner as for the ingress node 14 of the switchback LSP 21. The switchback LSP label which is pushed by the intermediate node 13 when it so inserts a packet into the switchback tunnel may be the same as that pushed by node 14, or it may take into account any swap operation performed along the switchback LSP 21 between the outputs of nodes 14 and 13 (their inputs along the primary path 20).

The determination of which LSPs should be protected, as well as the architecture of the backup and/or switchback LSPs, is a matter of network design and operations-and-maintenance policy for the MPLS network operator. Once this is decided, the LSPs can be established and configured as described previously.

The text of the abstract repeated below is hereby deemed incorporated in the description:

A primary label switched path (LSP) defined in a label switching network has a protected portion for transmitting data packets containing a label stack from a first label switching node to a second label switching node, the protected portion including at least one intermediate label switching node between the first and second nodes. To provide path recovery resources in case of link or node failure, it is proposed a method in which a backup LSP is defined from the first node to the second node. A transformation of the label stack of a packet transmitted along the protected portion of the primary LSP from an output of the first node to an input of the second node is determined. The first node is configured to switch a packet to the backup LSP upon detection of a failure in the protected portion of the primary LSP. In addition, a node of the backup LSP is configured to process the label stack of any packet transmitted along the backup LSP so as to apply the determined transformation.

I claim:

1. A method of providing backup resources for a primary label switched path (LSP) in a label switching network, the primary LSP having at least a portion for transmitting data packets containing a label stack from a first label switching node to a second label switching node, said portion including at least one intermediate label switching node between the first and second nodes, the method comprising the steps of:
defining at least one backup LSP starting from the first node and merged with the primary LSP at the second node;
determining a transformation of the label stack of a packet transmitted along said portion of the primary LSP from an output of the first node to an input of the second node;
configuring the first node to switch a packet to the backup LSP upon detection of a failure in said portion of the primary LSP; and
configuring at least one node of the backup LSP to process the label stack of any packet transmitted along the backup LSP so as to apply said transformation.

2. A method as claimed in claim 1, wherein the node of the backup LSP configured to apply the transformation is the first node, said transformation being applied prior to pushing a label of the backup LSP.

3. A method as claimed in claim 1, wherein the node of the backup LSP configured to apply the transformation is the second node.

4. A method as claimed in claim 1, wherein the step of determining the transformation of the label stack comprises transmitting messages of a signaling protocol between the nodes of said portion of the primary LSP, including indications of label stack manipulations performed by said nodes on packets transmitted along the primary LSP, said indications being processed at one of the first and second nodes for deriving said transformation.

5. A method as claimed in claim 1, wherein the step of determining the transformation of the label stack comprises transmitting at least one sample packet from the first node to the second node along said portion of the primary LSP.

6. A method as claimed in claim 1, wherein the first node is configured to switch a packet intended for the primary LSP to the backup LSP upon detection of a failure in said portion of the primary LSP up to the intermediate node situated next to the first node.

7. A method as claimed in claim 1, further comprising the steps of:
defining at least one switchback LSP from an intermediate node of the primary LSP to the first node; and
configuring said intermediate node to switch a packet to the switchback LSP upon detection of a failure in said portion of the primary LSP downstream of said intermediate node and up to the node situated next to said intermediate node.

8. A method as claimed in claim 7, further comprising the step of configuring the first node to switch to the backup LSP any packet received on the switchback LSP.

9. A method as claimed in claim 8, further comprising the steps of:
determining a second transformation of the label stack as the inverse of a transformation of the label stack of a packet transmitted along said portion of the primary LSP from the output of the first node to said intermediate node; and
configuring at least one node of the switchback LSP to process the label stack of any packet transmitted from said intermediate node along the switchback LSP so as to apply said second transformation.

10. A method as claimed in claim 9, wherein the node of the switchback LSP configured to apply the second transformation is said intermediate node, the second transformation being applied prior to pushing a label of the switchback LSP.

11. A method as claimed in claim 10, wherein the primary LSP has at least one additional intermediate node between the first node and said intermediate node, wherein the switchback LSP is defined to comprise the nodes of the primary LSP, in a reverse direction, from said intermediate node to the first node.

12. A method as claimed in claim 11, further comprising the step of configuring said additional intermediate node to switch a packet to the switchback LSP upon detection of a failure in said portion of the primary LSP downstream of said additional intermediate node and up to the node situated next to said additional intermediate node.

13. A method as claimed in claim 12, further comprising the steps of:
determining a third transformation of the label stack as the inverse of a transformation of the label stack of a packet transmitted along said portion of the primary LSP from the output of the first node to said additional intermediate node; and
configuring said additional intermediate node to process the label stack of any packet that it switches to the switchback LSP so as to apply said inverse transformation prior to pushing a label of the switchback LSP.

14. A label switching network including a primary label switched path (LSP) having at least a portion for transmitting data packets containing a label stack from a first label switching node to a second label switching node, said portion including at least one intermediate label switching node between the first and second nodes, the network comprising:
means for defining at least one backup LSP starting from the first node and merged with the primary LSP at the second node;
means for determining a transformation of the label stack of a packet transmitted along said portion of the primary LSP from an output of the first node to an input of the second node;
means for configuring the first node to cause said first node to switch a packet to the backup LSP upon detection of a failure in said portion of the primary LSP; and
means for configuring a node of the backup LSP to cause said node to process the label stack of any packet transmitted along the backup LSP so as to apply said transformation.

15. A label switching network as claimed in claim 14, wherein the node of the backup LSP configured to apply the transformation is the first node, said transformation being applied prior to pushing a label of the backup LSP.

16. A label switching network as claimed in claim 14, wherein the node of the backup LSP configured to apply the transformation is the second node.

17. A label switching network as claimed in claim 1, wherein the means for determining the transformation of the label stack comprise means for transmitting messages of a signaling protocol between the nodes of said portion of the primary LSP, including indications of label stack manipulations performed by said nodes on packets transmitted along the primary LSP, and processing means for processing said indications at one of the first and second nodes for deriving said transformation.

18. A label switching network as claimed in claim 14, wherein the means for determining the transformation of the label stack comprise means for transmitting at least one sample packet from the first node to the second node along said portion of the primary LSP.

19. A label switching network as claimed in claim 14, wherein the first node is configured to switch a packet intended for the primary LSP to the backup LSP upon detection of a failure in said portion of the primary LSP up to the intermediate node situated next to the first node.

20. A label switching network as claimed in claim 14, further comprising:
means for defining at least one switchback LSP from an intermediate node of the primary LSP to the first node; and
means for configuring said intermediate node to cause said intermediate node to switch a packet to the switchback LSP upon detection of a failure in said portion of the primary LSP downstream of said intermediate node and up to the node situated next to said intermediate node.

21. A label switching network as claimed in claim 20, further comprising means for configuring the first node to cause said first node to switch to the backup LSP any packet received on the switchback LSP.

22. A label switching network as claimed in claim 20, further comprising:
means for determining a second transformation of the label stack as the inverse of a transformation of the label stack of a packet transmitted along said portion of the primary LSP from the output of the first node to said intermediate node; and
means for configuring a node of the switchback LSP to cause said node to process the label stack of any packet transmitted from said intermediate node along the switchback LSP so as to apply said second transformation.

23. A label switching network as claimed in claim 22, wherein the node of the switchback LSP configured to apply the second transformation is said intermediate node, the second transformation being applied prior to pushing a label of the switchback LSP.

24. A label switching network as claimed in claim 23, wherein the primary LSP has at least one additional intermediate node between the first node and said intermediate node, wherein the switchback LSP is defined to comprise the nodes of the primary LSP, in a reverse direction, from said intermediate node to the first node.

25. A label switching network as claimed in claim 24, further comprising means for configuring said additional intermediate node to cause said additional intermediate node to switch a packet to the switchback LSP upon detection of a failure in said portion of the primary LSP downstream of said additional intermediate node and up to the node situated next to said additional intermediate node.

26. A label switching network as claimed in claim 25, further comprising:
means for determining a third transformation of the label stack as the inverse of a transformation of the label stack of a packet transmitted along said portion of the primary LSP from the output of the first node to said additional intermediate node; and
means for configuring said additional intermediate node to cause said additional intermediate node to process the label stack of any packet that it switches to the switchback LSP so as to apply said inverse transformation prior to pushing a label of the switchback LSP.
